(19) United States
(12) Patent Application Publication
(10) Pub. No.: US 2021/0295430 A1
(43) Pub. Date: Sep. 23, 2021

(54) MARKET ABUSE DETECTION

(71) Applicant: International Business Machines Corporation, Armonk, NY (US)

(72) Inventors: Srinivasan S. Muthuswamy, Bangalore (IN); Subhendu Das, Chapel Hill, NC (US); Yashodhara M. Patnaik, Pune (IN)

(21) Appl. No.: 16/823,955

(22) Filed: Mar. 19, 2020

(51) Int. Cl. G06Q 40/04; G06Q 20/40; G06N 3/06; G06N 3/08; G06N 20/00

(52) U.S. Cl. CPC G06Q 40/04; G06Q 20/4016; G06N 20/00; G06N 3/08; G06N 3/06

(57) ABSTRACT

A computer-implemented method for detecting market abuse in a data processing system, the method comprising: collecting a plurality of first events associated with a first stock trade occurring within a predetermined period of time; grouping the plurality of first events into different event groups, each group having a different type of first events; encoding each first event as one or more characters, and encoding each type of first events as a first string; collecting all the first strings in a sequence corresponding to different types of first events; feeding the sequence of first strings into a trained machine learning model; and determining, by the trained machine learning model, whether there is market abuse in the first stock trade.

### TECHNICAL FIELD

The present application generally relates to market abuse detection, and more particularly, to detection of market abuse using events associated with a stock trade.

### BACKGROUND

There is a regulatory need for monitoring activities of traders at an exchange level or at a brokerage firm level to make sure that stock trades are fair. Market abuse may arise in circumstances where financial market investors have been unreasonably disadvantaged. Typically, traders can access some prior information, which may act as a key to manipulate the stock for personal gain. Trade patterns for market abuse are well known, but it is increasingly difficult to detect the trade patterns due to the involvement of a large amount of information, such as market events, news events, and communication events.

Thus, it is desired to introduce an approach of detecting market abuse in a stock trade.

### SUMMARY

Embodiments provide a computer-implemented method for detecting market abuse in a data processing system comprising a processor and a memory comprising instructions which are executed by the processor, the method comprising: collecting, by the processor, a plurality of first events associated with a first stock trade occurring within a predetermined period of time; grouping, by the processor, the plurality of first events into different event groups, each group having a different type of first events; encoding, by the processor, each first event as one or more characters, and encoding, by the processor, each type of first events as a first string; collecting, by the processor, all the first strings in a sequence corresponding to different types of first events; feeding, by the processor, the sequence of first strings into a trained machine learning model; and determining, by the trained machine learning model, whether there is market abuse in the first stock trade.

Embodiments provide a computer-implemented method for detecting market abuse, further comprising: training, by the processor, a machine learning model. The step of training further comprises: collecting, by the processor, a plurality of second events associated with a second stock trade occurring within the predetermined period of time; grouping, by the processor, the plurality of second events into different event groups, each group having a different type of second events; encoding, by the processor, each second event as the one or more characters and encoding, by the processor, each type of second events as a second string; collecting, by the processor, all the second strings in a sequence corresponding to different types of second events and a label as ground truth, wherein the label indicates whether the second stock trade is market abuse or not; and feeding, by the processor, the sequence of second strings and the label into the machine learning model to train the machine learning model.

Embodiments provide a computer-implemented method for detecting market abuse, wherein the machine learning model is based on a deep neural network, wherein each second event is assigned with a neuron.

Embodiments provide a computer-implemented method for detecting market abuse, wherein the plurality of first events and the plurality of second events include one or more of order events, price changes, volume changes, time events, news events, communication events, market events, and corporate actions.

Embodiments provide a computer-implemented method for detecting market abuse, wherein the first stock trade and the second stock trade are performed by a same trader for a same stock symbol.

Embodiments provide a computer-implemented method for detecting market abuse, wherein each type of first events is encoded as a different character or a different character pair.

Embodiments provide a computer-implemented method for detecting market abuse, further comprising: visually showing all the first events on a stock chart if there is the market abuse in the first stock trade.

In another illustrative embodiment, a computer program product comprising a computer usable or readable medium having a computer readable program is provided. The computer readable program, when executed on a processor, causes the processor to perform various ones of, and combinations of, the operations outlined above with regard to the method illustrative embodiment.

In yet another illustrative embodiment, a system is provided. The system may comprise a full question generation processor configured to perform various ones of, and combinations of, the operations outlined above with regard to the method illustrative embodiment.

Additional features and advantages of this disclosure will be made apparent from the following detailed description of illustrative embodiments that proceeds with reference to the accompanying drawings.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 depicts a schematic diagram of one illustrative embodiment of a cognitive system 100 implementing an exemplary market abuse detection system 110 in a computer network;

FIG. 2 depicts a schematic diagram of one illustrative embodiment of the market abuse detection system 110, according to embodiments described herein;

FIG. 3 illustrates a flowchart diagram depicting a method 300 of training a machine learning model used for detecting market abuse, according to embodiments described herein;

FIG. 4 illustrates a flowchart diagram depicting an exemplary method 400 for detecting a market abuse, according to embodiments described herein; and

FIG. 5 is a block diagram of an example data processing system 500 in which aspects of the illustrative embodiments are implemented.

### DETAILED DESCRIPTION OF EXEMPLARY EMBODIMENTS

The present invention may be a system, a method, and/or a computer program product implemented on a cognitive system. The computer program product may include a computer readable storage medium (or media) having computer readable program instructions thereon for causing a processor to carry out aspects of the present invention.

As an overview, a cognitive system is a specialized computer system, or set of computer systems, configured with hardware and/or software logic (in combination with hardware logic upon which the software executes) to emulate human cognitive functions. These cognitive systems apply human-like characteristics to conveying and manipulating ideas which, when combined with the inherent strengths of digital computing, can solve problems with high accuracy and resilience on a large scale. IBM Watson™ is an example of one such cognitive system which can process human-readable language and identify inferences between text passages with human-like accuracy at speeds far faster than human beings and on a much larger scale. In general, such cognitive systems can perform the following functions:
Navigate the complexities of human language and understanding
Ingest and process vast amounts of structured and unstructured data
Generate and evaluate hypotheses
Weigh and evaluate responses that are based only on relevant evidence
Provide situation-specific advice, insights, and guidance
Improve knowledge and learn with each iteration and interaction through machine learning processes
Enable decision making at the point of impact (contextual guidance)
Scale in proportion to the task
Extend and magnify human expertise and cognition
Identify resonating, human-like attributes and traits from natural language
Deduce various language-specific or agnostic attributes from natural language
High degree of relevant recollection from data points (images, text, voice) (memorization and recall)
Predict and sense with situation awareness that mimic human cognition based on experiences
Answer questions based on natural language and specific evidence

In one aspect, the cognitive system can be augmented with a market abuse detection system. In an embodiment, the market abuse detection system can train a deep machine learning model with events related to a large number of stock trades performed by a particular trader for a particular stock symbol. The market abuse detection system can collect all the events related to each stock trade, including order events, price change, volume change, time events, communication events, news events, market events, and corporate actions, etc., and encode each type of events into a string. All the strings, together with a label indicating market abuse or market non-abuse, are collected together to form a sequence of strings, which is then used to train a deep machine learning model.

The market abuse detection system can further collect all the events related to a new stock trade, including order events, price change, volume change, time events, communication events, news events, market events, and corporate actions, etc., and encode each type of events into a string. All the strings are collected together to form a sequence of strings, which is then inputted into a trained deep machine learning model. The trained deep machine learning model can determine whether the new stock trade involves a market abuse or not.

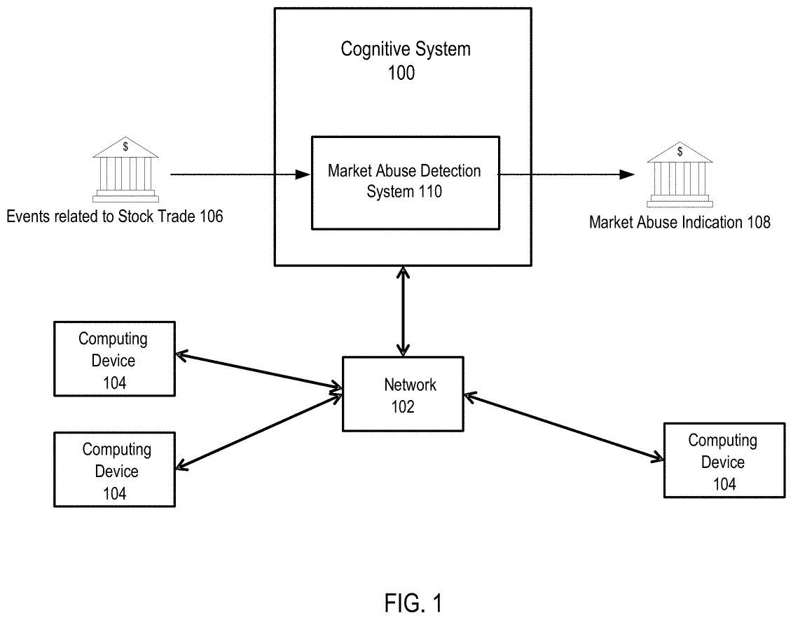

FIG. 1 depicts a schematic diagram of one illustrative embodiment of a cognitive system 100 implementing an exemplary market abuse detection system 110 in a computer network 102. The cognitive system 100 is implemented on one or more computing devices 104 (comprising one or more processors and one or more memories, and potentially any other computing device elements generally known in the art including buses, storage devices, communication interfaces, and the like) connected to the computer network 102. The computer network 102 includes multiple computing devices 104 in communication with each other and with other devices or components via one or more wired and/or wireless data communication links, where each communication link comprises one or more of wires, routers, switches, transmitters, receivers, or the like. Other embodiments of the cognitive system 100 may be used with components, systems, sub-systems, and/or devices other than those that are depicted herein. The computer network 102 includes local network connections and remote connections in various embodiments, such that the cognitive system 100 may operate in environments of any size, including local and global, e.g., the Internet. The cognitive system 100 is configured to implement a market abuse detection system 110 that can automatically identify market abuse involvement in a stock trade. Different types of events related to a stock trade 106 for a particular stock trade are inputted into the market abuse detection system 110, which will output a market abuse indication 108 if there is market abuse involvement in this stock trade.

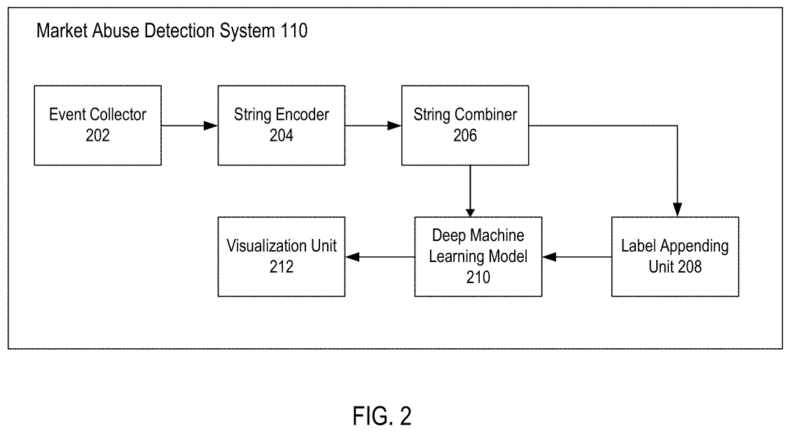

FIG. 2 depicts a schematic diagram of one illustrative embodiment of the market abuse detection system 110, according to embodiments described herein. As shown in FIG. 2, in an embodiment, the market abuse detection system 110 includes event collector 202, string encoder 204, string combiner 206, label appending unit 208, deep machine learning model 210, and visualization unit 212. The event collector 202 is configured to collect different types of events associated with a stock trade. The string encoder 204 is configured to encode each type of events into a string. The string combiner 206 is configured to combine all the strings together to form a long string. The label appending unit 208 is configured to append a label indicating market abuse or market non-abuse at the end of the long string or a sequence of strings. For example, the label “A” indicates a market abuse in the stock trade while the label “NA” indicates a market non-abuse in the stock trade. The deep machine learning model 210 can be trained by a large number of stock trades performed by a particular trader for a particular stock symbol, each stock trade corresponding to a long string or a sequence of strings, including a label indicating market abuse or market non-abuse. The trained deep machine learning model 210 is configured to determine whether there is any market abuse involved in a new stock trade. The visualization unit 212 is configured to visualize all the events and the market abuse on a stock chart. In another embodiment, if the deep machine learning model 210 has completed training, then the long string can be directly sent to the trained deep machine learning model 210, skipping the label appending unit 208. The deep machine learning model 210 can determine whether there is any market abuse involved in a new stock trade.

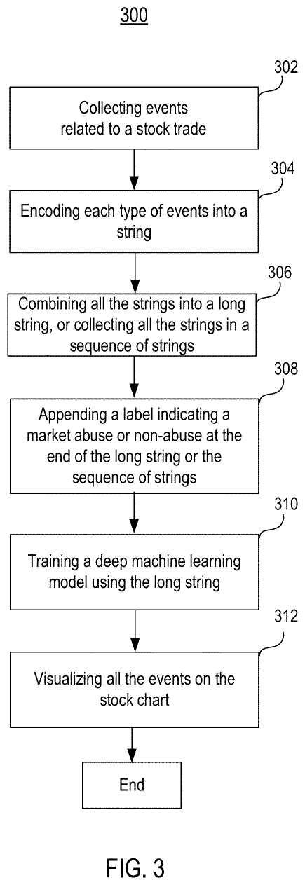

FIG. 3 illustrates a flowchart diagram depicting a method 300 of training a machine learning model used for detecting a market abuse, according to embodiments described herein. At step 302, different types of events related to a stock trade, such as order events (order, cancel order, update order, execution), price (moving up, moving down), volume (increase, decrease), time events (event, no events), communication events, market events, news events, corporate actions, etc., are collected. The stock trade is managed by a particular trader (e.g., TD Ameritrade) for a particular stock symbol (e.g., International Business Machines stock). The events related to a stock trade in a predetermined period of time can be collected. For example, the events can be collected at a day level.

At step 304, each event is encoded as a character or a character pair (i.e., two characters), and each type of events is encoded as a string. For example, order events, such as “order,” “cancel,” “order,” “cancel,” “order,” “execution,” can be encoded as “OCOCOCOCEE” (“O” represents placing an order, while “C” represents canceling an order). If there is a price moving up, it can be encoded as the “UUUUUUUUU----” (“U” represents increase of price, while “-” indicates no events), while there is a price moving down, it can be encoded as the “LLLLL----” (“L” represents decrease of price). Similarly, the other key features can be encoded as below: Volume: “IDDDDDDI-----” (“I” represents increase of volume, while “D” represents decrease of volume); Time: “E-E-----E----E--” (“E” represents a template configured to capture events such as communication events, market events, corporate actions. If there is “E,” it indicates that an event (communication event, market event, news event, or corporate action) will occur; Communication events: -----CE-----CE---- (“CE” represents communications between traders or between a trader and a third party, e.g., emails, phone calls, online chat, etc. For example, trader A chats with trader B; trader A is sending an email to a third party P1; trader B is making a phone call with a third party P2 about the ticker, i.e., stock symbol.); Market Events: “-----ME-------------ME--” (“ME” represents market events, e.g., market news. Specifically, if a subscription to market news is made, market news regarding the market trend (e.g., the oil industry is not doing well) will be provided.); Corporate Actions: -----CA---CA---CA-----CA (“CA” represents corporate actions. Corporate actions can be corporate news that can influence a stock. For example, any company announcements, such as appointing a new CEO or a new board member, board meetings, stock share changes owned by key shareholders, acquisitions/mergers, quarterly result announcements, etc., are corporate actions).

At step 306, strings corresponding to different types of events can be combined together to form a long string, e.g., “OCOUU-COIDDD-COIDD--CEMEMECAMECACOEE.” Alternatively, these strings are not combined, and they are just collected together in a sequence.

At step 308, at the end of the long string or the sequence of strings, a label (“A” indicating a market abuse or “NA” indicating a market non-abuse) is appended to indicate that the stock trade is normal or abnormal (i.e., anomalous).

At step 310, the long string or the sequence of strings representing all the events are fed into a deep neural network (DNN), e.g., a bi-directional long short term memory (LSTM), to train a deep machine learning model, so as to differentiate the normal execution from anomalous execution, i.e., market abuse scenarios. Each character or each character pair of the strings represents an activity or event of a trader. Thus, the deep learning model can be trained to detect which stock trade is abnormal (i.e., the involvement of market abuse).

The DNN includes an input layer, one or more hidden layers, and an output layer (an output result is “true” or “false”). The input layer including hundreds of neurons to form an input neural network of the DNN. The input sequence of strings includes ground truth to indicate that the trade pattern is market abuse or not. For example, a sequence of strings “OCOCOCOCOCOCOCOCOCOC---------OOOOO------------UUUUUUUUUUUUU---------IIIIIIIIIIIIIIIIIIIIIIIIIIIIIIIDDDDDDDDDDDD------A” can be input into the input layer, wherein “A” indicates this trade pattern involves market abuse. For another example, a sequence of strings “OCOCOC---------OOOOO--------DDDDDDD-------DDDDDDDD------NA” can be input into the input layer, wherein “NA” indicates this trade pattern does not involve market abuse. The one or more hidden layers can translate the input into a hidden context, and the output layer can provide a result that the trade pattern is a market abuse or not. Each event (each feature) can be assigned with a neuron. The machine learning model can learn co-relations between the events, and identify which combination of events corresponds to market abuse. A large number of sequences of strings having a label indicating market abuse or non-abuse are provided to train the DNN.

At step 312, all the events are visually shown on a stock chart if there is market abuse, so that the user, e.g., data scientists, can perform further analysis about the market abuse.

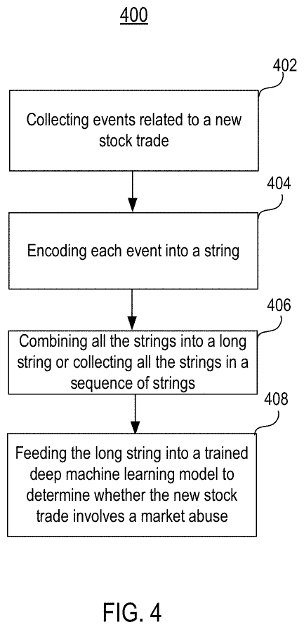

FIG. 4 illustrates a flowchart diagram depicting an exemplary method 400 for detecting a market abuse, according to embodiments described herein. At step 402, all the events related to a new stock trade are collected and grouped at the trader/ticker level into different event groups, each group having a different type of events. Trader activities (i.e., order events) are grouped at trader-ticker level (e.g., trader orders, trader communications). The rest of the events are grouped at the ticker level (e.g., corporate actions, market events). A predetermined time window is set, and the events can be collected at a level of the predetermined time window (e.g., every day, or every 5 hours, etc.)

At step 404, each type of events is encoded as a string. For example, if a trader attempts spoofing, the trader activities may include repetitive “order” events and “cancel” events. Further, the ticker event shows price moving up, and the trader buys stock, and then sells it at a higher price capitalizing the market. This stock trade can be identified as involving market abuse. The different types of events, for example, can be encoded as below:
Trader activity: OCOCOCOCOCOCOCOCOCOC------------------OOOOO-----------
Price: ---------------------------------UUUUUUUUUUUUUU-------------------
volume: ------------------------IIIIIIIIIIIIIIIIIIIIIIIIIIIIIIIDDDDDDDDDDDD------

At step 406, all the encoded strings are combined to form a long string or collected in a sequence. For example, the above three strings are combined to form a long string. Alternatively, the three strings are not combined, and they are just collected in a sequence.

At step 408, the long string or the sequence of strings is fed into the trained deep machine learning model to decide whether there is any market abuse in the new stock trade. There is no label indicating market abuse or non-abuse at the end of the long string or the sequence of strings. The machine learning model, after being trained successfully by the group truth as illustrated in step 310, can determine whether there is any market abuse in the new stock trade.

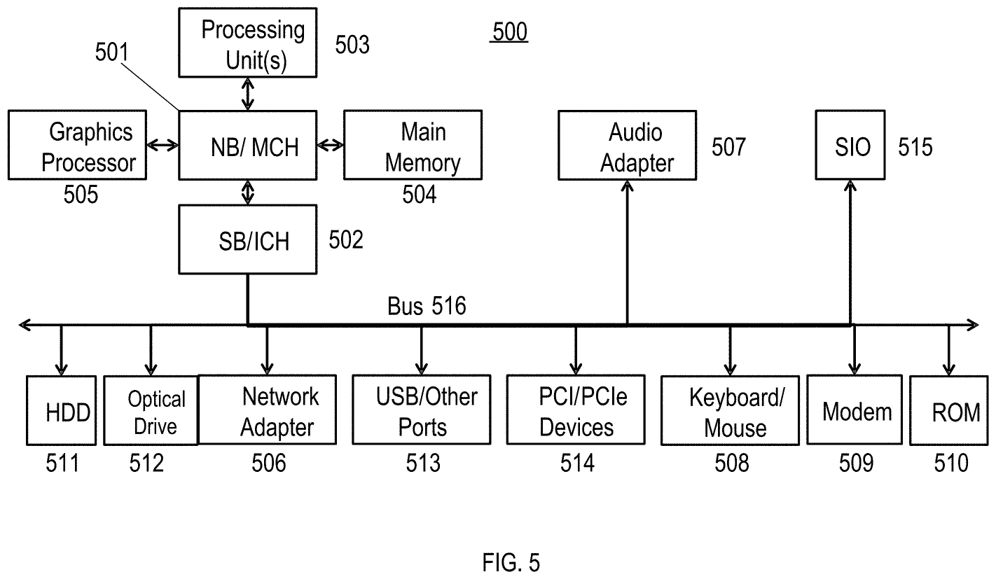

FIG. 5 is a block diagram of an example data processing system 500 in which aspects of the illustrative embodiments are implemented. Data processing system 500 is an example of a computer, such as a server or a client, in which computer usable code or instructions implementing the process for illustrative embodiments of the present invention are located. In one embodiment, FIG. 5 represents a server computing device, such as a server, which implements the market abuse detection system 110 and cognitive system 100 described herein.

In the depicted example, the data processing system 500 can employ a hub architecture including a north bridge and memory controller hub (NB/MCH) 501 and south bridge and input/output (I/O) controller hub (SB/ICH) 502. Processing unit 503, main memory 504, and graphics processor 505 can be connected to the NB/MCH 501. Graphics processor 505 can be connected to the NB/MCH 501 through an accelerated graphics port (AGP).

In the depicted example, the network adapter 506 connects to the SB/ICH 502. The audio adapter 507, keyboard and mouse adapter 508, modem 509, read-only memory (ROM) 510, hard disk drive (HDD) 511, optical drive (CD or DVD) 512, universal serial bus (USB) ports and other communication ports 513, and the PCl/PCIe devices 514 can connect to the SB/ICH 502 through bus system 516. PCl/PCIe devices 514 may include Ethernet adapters, add-in cards, and PC cards for notebook computers. ROM 510 may be, for example, a flash basic input/output system (BIOS). The HDD 511 and optical drive 512 can use an integrated drive electronics (IDE) or serial advanced technology attachment (SATA) interface. The super I/O (SIO) device 515 can be connected to the SB/ICH.

An operating system can run on processing unit 503. The operating system can coordinate and provide control of various components within the data processing system 500. As a client, the operating system can be a commercially available operating system. An object-oriented programming system, such as the Java′ programming system, may run in conjunction with the operating system and provide calls to the operating system from the object-oriented programs or applications executing on the data processing system 500. As a server, the data processing system 500 can be an IBM® eServer™ System p® running the Advanced Interactive Executive operating system or the Linux operating system. The data processing system 500 can be a symmetric multiprocessor (SMP) system that can include a plurality of processors in the processing unit 503. Alternatively, a single processor system may be employed.

Instructions for the operating system, the object-oriented programming system, and applications or programs are located on storage devices, such as the HDD 511, and are loaded into the main memory 504 for execution by the processing unit 503. The processes for embodiments of the full question generation system can be performed by the processing unit 503 using computer usable program code, which can be located in a memory such as, for example, main memory 504, ROM 510, or in one or more peripheral devices.

A bus system 516 can be comprised of one or more busses. The bus system 516 can be implemented using any type of communication fabric or architecture that can provide for a transfer of data between different components or devices attached to the fabric or architecture. A communication unit such as the modem 509 or network adapter 506 can include one or more devices that can be used to transmit and receive data.

Those of ordinary skill in the art will appreciate that the hardware depicted in FIG. 5 may vary depending on the implementation. For example, the data processing system 500 includes several components which would not be directly included in some embodiments of the market abuse detection system 110. However, it should be understood that the market abuse detection system 110 may include one or more of the components and configurations of the data processing system 500 for performing processing methods and steps in accordance with the disclosed embodiments.

Moreover, other internal hardware or peripheral devices, such as flash memory, equivalent non-volatile memory, or optical disk drives may be used in addition to or in place of the hardware depicted. Moreover, the data processing system 500 can take the form of any of a number of different data processing systems, including but not limited to, client computing devices, server computing devices, tablet computers, laptop computers, telephone or other communication devices, personal digital assistants, and the like. Essentially, a data processing system 500 can be any known or later developed data processing system without architectural limitation.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a head disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network (LAN), a wide area network (WAN) and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object-oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including LAN or WAN, or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical functions. In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The present description and claims may make use of the terms “a,” “at least one of,” and “one or more of,” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples are intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the example provided herein without departing from the spirit and scope of the present invention.

The system and processes of the Figures are not exclusive. Other systems, processes and menus may be derived in accordance with the principles of embodiments described herein to accomplish the same objectives. It is to be understood that the embodiments and variations shown and described herein are for illustration purposes only. Modifications to the current design may be implemented by those skilled in the art, without departing from the scope of the embodiments. As described herein, the various systems, subsystems, agents, managers, and processes can be implemented using hardware components, software components, and/or combinations thereof. No claim element herein is to be construed under the provisions of 35 U.S.C. 112, sixth paragraph, unless the element is expressly recited using the phrase “means for.”

Although the invention has been described with reference to exemplary embodiments, it is not limited thereto. Those skilled in the art will appreciate that numerous changes and modifications may be made to the preferred embodiments of the invention and that such changes and modifications may be made without departing from the true spirit of the invention. It is therefore intended that the appended claims be construed to cover all such equivalent variations as fall within the true spirit and scope of the invention.

What is claimed is:

1. A computer-implemented method for detecting market abuse in a data processing system comprising a processor and a memory comprising instructions which are executed by the processor, the method comprising:
collecting, by the processor, a plurality of first events associated with a first stock trade occurring within a predetermined period of time;
grouping, by the processor, the plurality of first events into different event groups, each group having a different type of first events;
encoding, by the processor, each first event as one or more characters, and encoding, by the processor, each type of first events as a first string;
collecting, by the processor, all the first strings in a sequence corresponding to different types of first events;
feeding, by the processor, the sequence of first strings into a trained machine learning model; and
determining, by the trained machine learning model, whether there is market abuse in the first stock trade.

2. The method of claim 1, further comprising:
training, by the processor, a machine learning model,
wherein the step of training further comprises:
collecting, by the processor, a plurality of second events associated with a second stock trade occurring within the predetermined period of time;
grouping, by the processor, the plurality of second events into different event groups, each group having a different type of second events;
encoding, by the processor, each second event as the one or more characters and encoding, by the processor, each type of second events as a second string;
collecting, by the processor, all the second strings in a sequence corresponding to different types of second events and a label as ground truth, wherein the label indicates whether the second stock trade is market abuse or not; and
feeding, by the processor, the sequence of second strings and the label into the machine learning model to train the machine learning model.

3. The method of claim 2, wherein the machine learning model is based on a deep neural network, wherein each second event is assigned with a neuron.

4. The method of claim 2, wherein the plurality of first events and the plurality of second events include one or more of order events, price changes, volume changes, time events, news events, communication events, market events, and corporate actions.

5. The method of claim 2, wherein the first stock trade and the second stock trade are performed by a same trader for a same stock symbol.

6. The method of claim 1, wherein each type of first events is encoded as a different character or a different character pair.

7. The method of claim 1, further comprising:
visually showing all the first events on a stock chart if there is the market abuse in the first stock trade.

8. A computer program product for market abuse detection, the computer program product comprising a computer readable storage medium having program instructions embodied therewith, the program instructions executable by a processor to cause the processor to:
collect a plurality of first events associated with a first stock trade occurring within a predetermined period of time;
group the plurality of first events into different event groups, each group having a different type of first events;
encode each first event as one or more characters, and encode each type of first events as a first string;
combine all the first strings corresponding to different types of first events to form a first long string;
feed the first long string into a trained machine learning model; and
determine, by the trained machine learning model, whether there is market abuse in the first stock trade.

9. The computer program product as recited in claim 8, wherein the processor is further caused to train a machine learning model,
wherein the step of training further causes the processor to:
collect a plurality of second events associated with a second stock trade occurring within the predetermined period of time;
group the plurality of second events into different event groups, each group having a different type of second events;
encode each second event as the one or more characters and encode each type of second events as a second string;
combine all the second strings corresponding to different types of second events to form a second long string;
append a label at the end of the second long string, wherein the label indicates whether the second stock trade is market abuse or not; and
feed the second long string into the machine learning model to train the machine learning model.

10. The computer program product as recited in claim 9, wherein the machine learning model is based on a deep neural network, wherein each second event is assigned with a neuron.

11. The computer program product as recited in claim 9, wherein the plurality of first events and the plurality of second events include one or more of order events, price changes, volume changes, time events, communication events, market events, and corporate actions.

12. The computer program product as recited in claim 9, wherein the first stock trade and the second stock trade are performed by a same trader for a same stock symbol.

13. The computer program product as recited in claim 8, wherein each type of first events is encoded as a different character or a different character pair.

14. The computer program product as recited in claim 8, wherein the processor is further caused to visually show all the first events on a stock chart if there is the market abuse in the first stock trade.

15. A system for identifying market abuse, comprising:
a processor configured to:
collect a plurality of first events associated with a first stock trade occurring within a predetermined period of time;
group the plurality of first events into different event groups, each group having a different type of first events;
encode each first event as one or more characters, and encode each type of first events as a first string;
combine all the first strings corresponding to different types of first events to form a first long string;
feed the first long string into a trained machine learning model; and
determine, by the trained machine learning model, whether there is market abuse in the first stock trade.

16. The system as recited in claim 15, wherein the processor is further configured to train a machine learning model,
wherein the step of training further configures the processor to:
collect a plurality of second events associated with a second stock trade occurring within the predetermined period of time;
group the plurality of second events into different event groups, each group having a different type of second events;
encode each second event as the one or more characters and encode each type of second events as a second string;
combine all the second strings corresponding to different types of second events to form a second long string;
append a label at the end of the second long string, wherein the label indicates whether the second stock trade is market abuse or not; and
feed the second long string into the machine learning model to train the machine learning model.

17. The system as recited in claim 16, wherein the machine learning model is based on a deep neural network, wherein each second event is assigned with a neuron.

18. The system as recited in claim 16, wherein the plurality of first events and the plurality of second events include one or more of order events, price changes, volume changes, time events, communication events, market events, and corporate actions.

19. The system as recited in claim 16, wherein the first stock trade and the second stock trade are performed by a same trader for a same stock symbol.

20. The system as recited in claim 15, wherein each type of first events is encoded as a different character or a different character pair.
